(19) United States
(12) Patent Application Publication
(10) Pub. No.: US 2011/0002357 A1
(43) Pub. Date: Jan. 6, 2011

(54) SCREENING INSTALLATION

(75) Inventors: Ives Jean Jenny Ghislain Swennen, Hansbeke (BE); Kris Luc Rob Coen, Lede (BE)

Correspondence Address: OLIFF & BERRIDGE, PLC, P.O. BOX 320850, ALEXANDRIA, VA, 22320-4850, US

(73) Assignee: Bonar Technical Fabrics N.V., Zele (BE)

(21) Appl. No.: 12/919,628

(22) PCT Filed: Feb. 16, 2009
(86) PCT No.: PCT/EP2009/051790

§ 371 Date: Aug. 26, 2010

(30) Foreign Application Priority Data
Feb. 27, 2008 (EP) 08003521.5

(51) Int. Cl. G01K 13/00

(52) U.S. Cl. 374/141; 374/E13.001

(57) ABSTRACT

A screening installation is provided that detects a fire in a greenhouse. The screening installation has at least one screening fabric with an upper side and a rear side, and a first set of polymeric or metallic wires arranged proximate to the upper side of the at least one screening fabric so that a displacement of the fabric is restricted by the first set of polymeric or metallic wires. In addition, at least on of the polymeric or metallic wires in the first set of polymeric or metallic wires is replaced by a linear heat detection wire and/or the first set of polymeric or metallic wires is supplemented with at least one linear heat detection wire.

### CROSS-REFERENCE TO RELATED APPLICATION

This Application is a National Phase Application of PCT Application PCT/EP2009/051790 filed on Feb. 16, 2009 and claims priority from European Patent Application No. 08003521.5 filed on Feb. 27, 2008, the entire disclosure of which are incorporated herein by reference.

### BACKGROUND

The present invention relates to a screening installation that detects a fire in a greenhouse.

Screening installations in greenhouses are used, to control the interior climate of the greenhouse and decrease energy consumption. Such screening installations are designed to be compacted when the screening installations are not needed to reduce energy consumption and unfolded when the screening installations are needed to reduce energy consumption.

Existing screening installations place screening fabrics on a bed of support wires that are perpendicular to the length-wise direction of the screening fabrics. The support wires are made from, for example, polyester or polyamide and support the screening fabrics in both the compacted and unfolded states. Another set of wires is placed approximately 3 cm to 15 cm above the support wires to prevent undesired movement of the screening fabrics caused by, for example, a draft. Desired movement of the screening fabrics is caused by an electronically controlled electric motor.

Over the past decades, the number of electrical apparatuses and grow light systems in greenhouses has increased. These electrical apparatuses and grow light systems increase the likelihood of a fire occurring in a greenhouse. In fact, in most cases, these electrical apparatuses and grow light systems are the primary cause of fire. In addition, the screening fabrics are the main contributors to the spreading of fires within a greenhouse, which is related to the total damage of the fire.

To overcome this problem flame retarding screening fabrics are applied. However, flame retardancy brings with it, undesired changes in some important properties of the screening fabrics. Beside an increase in price, the screening fabrics become heavier and less flexible. This results in a less dense package formation that generates a higher amount of shading, thereby impeding plant growth and crop yield. Additionally, the intrinsic, environmentally unfriendly flame-retardants used in the flame retarding screening fabrics generate large amounts of dangerous and irritating fumes when exposed to fire.

Existing fire detection systems prevent the spreading of flames by triggering fire-suppressing counter measures such as, for example, closing the windows to suppress the supply of oxygen, shutting down the ventilation system, activating the sprinkler installation for a cooling effect and alerting a responsible person by any means.

In greenhouses, a single screening fabric can encompass a large area such as, for example, 5 m×100 m. Thus, compacting the screening fabrics to create an intermediate space between the fabrics to prevent the spread of fire from one screening fabric to another would be an important fire-suppressing countermeasure triggered by a fire detection system. However, because of the high ceilings and ventilation systems of a greenhouse, the density of point detection smoke detectors required for the screening fabric compacting counter measure would be too large and would render the screening fabric compacting countermeasure infeasible. In addition, the number of point detection smoke detectors placed above the plants would increase the amount of shade and would impede the growing yields of the plants.

Beam smoke detectors do not have this adverse shadowing effect because they are placed on the sides of the greenhouse. If the signal between source and reflector is disturbed by smoke, signaling can occur. However, as a consequence of the large distance between the sides of a greenhouse the beam smoke detector system has to be mounted into a very stable structure, which does not exist in a greenhouse. As a consequence until now, it was not possible to provide a feasible fire detection system in greenhouses.

Therefore, the problem underlying the present invention is to provide a feasible fire detection system in greenhouses.

### SUMMARY

This problem is solved by a screening installation that detects a fire in a greenhouse. In a first exemplary embodiment, the screening installation includes at least one screening fabric that has an upper side and a rear side and a first set of polymeric or metallic wires arranged proximate to the upper side of the at least one screening fabric so that a displacement of the fabric is restricted by the first set of polymeric or metallic wires. In addition, at least one of the wires in the first set of wires is replaced by a linear heat detection wire and/or the first set of wires is supplemented with at least one linear heat detection wire.

In a second exemplary embodiment, the screening installation includes at least one screening fabric that has an upper side and a rear side. The screening installation also has a first set of polymeric or metallic wires arranged proximate to the upper side of the at least one screening fabric so that a displacement of the fabric is restricted by the first set of polymeric or metallic wires. The screening installation further has a second set of polymeric or metallic wires that is placed on the rear side of the at least one screening fabric and supports the fabric. At least one of the wires in the second set of wires is replaced by a linear heat detection wire and/or the second set of wires is supplemented with at least one linear heat detection wire.

In a third exemplary embodiment, the screening installation includes at least one screening fabric that has an upper side and a rear side. The screening installation also has a first set of polymeric or metallic wires arranged proximate to the upper side of the at least one screening fabric so that a displacement of the fabric is restricted by the first set of polymeric or metallic wires. The screening installation further has a second set of polymeric or metallic wires that is placed on the rear side of the at least one screening fabric and supports the fabric. At least one of the wires in the first and/or second set of wires is replaced by a linear heat detection wire and/or the first and/or second set of wires is supplemented with at least one linear heat detection wire.

### DETAILED DESCRIPTION OF EMBODIMENTS

For the purposes of this disclosure, “screening fabric” means any textile structure capable of providing shade in a greenhouse to control its climate and decrease its energy consumption. Suitable examples for a screening fabric include any woven fabric, e.g. of plain weave, or any knitted fabric. The woven or knitted fabric may include a yarn system or multifilament system and polymer tapes. The exemplary polymer tapes may be transparent, light and/or heat reflective or light and/or heat absorbing(e.g., tapes of black color).

Also for the purposes of this disclosure, “polymeric wires” means synthetic monofilaments such as wires consisting of filaments or staple fibers spun from a natural or synthetic polymer. Examples of natural polymers include cotton, sisal, manila, henequen, jute and hemp. Examples of synthetic polymers include polyester (e.g., polyethylene terephthalate, polyimide, polypropylene, polyethylene or polyacrylnitril (acrylic fibers)).

Also for the purposes of this disclosure, “metallic wires” means wires manufactured from steel, stainless steel, galvanized steel or coated steel (e.g., powder coated or plastic coated steel).

The screening installations according to the first through third exemplary embodiments provide a fire detection system in greenhouses by implementing heat detection wires, which either replace or supplement the polymeric or metallic wires in the first and/or second set of wires. When there is a fire, the heat detection wire(s) generate a short circuit electrical current, which in turn triggers counteracting actions such as, for example, closing the windows to suppress the supply of oxygen, shutting down the ventilation system, activating the sprinkler installation for a cooling effect, alerting the responsible person by any means or compacting the screening fabrics to create an intermediate space between the fabrics, thereby minimizing the destroying effect of a fire.

The heat detection wire(s) used in the screening installation of the present invention have a diameter that is similar in size as the diameter of the polymeric or metallic wires of the first set. The range of diameters of the heat detecting wires can be, for example, in the range of 1.5 mm to 5 mm, while the diameters of the polymeric or metallic wires of the first set of wires can be, for example, approximately 2 mm Therefore, the heat detection wires do not add a significant shadowing effect for the plants. Furthermore, it is very easy to replace and/or supplement the polymeric and metallic wires by the heat detecting wires. Consequently the screening installation of the first embodiment provides a feasible fire detection system in greenhouses.

Also according to the first through third exemplary embodiments of the screening installation, at least in the first set of polymeric or metallic wires at least one of the wires is replaced by a linear heat detection wire. In other words, one, two or more of the polymeric or metallic wires are replaced by a corresponding number of linear heat detection wires. If polymeric or metallic fibers of the second set are replaced by the heat detection wires, the replacing heat detection wires support the screening fabric (i.e., the heat detection fibers are attached to the screening fabric). The polymeric or metallic wires run perpendicularly and/or parallel to the length direction of the screening fabric. Consequently the same is the case for the substituted heat detection wires. Preferably the heat detection wires are distributed equidistant along the length direction of the fabric.

Also according to the first through third exemplary embodiments of the screening installation, at least the first set of polymeric or metallic wires is supplemented with at least one linear heat detection wire. In other words, the polymeric or metallic wires are supplemented with one, two or more of the linear heat detection wires, which may run perpendicularly and/or parallel to the length direction of the screening fabric. If polymeric or metallic fibers of the second set are supplemented by the heat detection wires, the supplementing heat detection wires also support the screening fabric, (i.e., the heat detection fibers are attached to the screening fabric). Preferably, also the supplementing heat detection wires are distributed equidistant along the length direction of the fabric.

It should be understood that in some exemplary embodiments, only wires of the first set of polymeric or metallic wires are replaced with linear heat detection wires. In other embodiments, only wires of the second set of polymeric or metallic wires are replaced with linear heat detection wires. In yet other embodiments, wires of both the first and second set of polymeric or metallic wires are replaced with linear heat detection wires. It should also be understood that in some exemplary embodiments, only the first set of polymeric or metallic wires is supplemented with linear heat detection wires. In other embodiments, only the second set of polymeric or metallic wires is supplemented with linear heat detection wires. In yet other embodiments, both the first and second set of polymeric or metallic wires are supplemented with linear heat detection wires. In addition, any of the embodiments in which polymeric or metallic wires are replaced with linear heat detection wires can be combined with any of the embodiments in which the first and/or second sets of polymeric or metallic wires are supplemented with linear heat detection wires.

Any of the above disclosed embodiments can also include at least one heat detection wire that is arranged above the first set of polymeric or metallic wires. The at least one heat detection wire may run parallel or perpendicular or at any desired angle to the length direction of the screening fabric.

For embodiments of the screening installation in which at least the first and/or second set of polymeric wires comprises at least two linear heat detection wires, the distance between adjacent linear heat detection wires is preferably within the range of 1 m to 200 m and most preferably within the range of 1 m to 50 m. In addition, each of the linear heat detection wires can comprise two twisted electrically conductive cables insulated by a polymer, which has a melting point that is greater than 80° C. and preferably just above the decomposition temperature of the screening fabric, which in many cases is around 100° C.

The electrically conductive cables of the linear heat detection wires may consist of any electrically conductive material, e.g. of one of the known electrically conducting polymers, or of a metal wire, e.g. manufactured from steel. The insulated electrically conductive cables, i.e. the detection cables, are twisted together to impose a permanent spring pressure between them. In the case of a fire or when the temperature near the linear heat detection wire rises above the melting point of the insulating polymer, the polymer melts and a short circuit occurs, which can trigger counter measures as described above. Linear heat detection wires comprising electrically conductive steel cables can be obtained e.g. from. Protectowire Co., Inc. (USA).

Consequently, those, who are skilled in the art will immediately recognize that the disclosed screening installation comprises a multitude of embodiments, from which they can choose one that is tailor-made for the structural conditions of a certain greenhouse that is provided with a screening installation capable capable of detecting a fire.

1. A screening installation for detecting a fire in a greenhouse, comprising:
at least one screening fabric that has an upper side and a rear side; and
a first set of polymeric or metallic wires arranged proximate to the upper side of the at least one screening fabric so that a displacement of the fabric is restricted,
wherein
in the first set of polymeric or metallic wires at least one of the wires is replaced by a linear heat detection wire and/or
the first set of polymeric or metallic wires is supplemented with at least one linear heat detection wire.

2. A screening installation according to claim 4, wherein at least the first set of polymeric wires comprises at least two linear heat detection wires and wherein the distance between adjacent linear heat detection wires is in the range from 1 m to 200 m.

3. A screening installation according to claim 4, wherein each of the linear heat detection wires comprise two twisted electrically conductive cables insulated by a polymer, which has a melting point greater than 80° C.

4. A screening installation according to claim 1, further comprising a second set of polymeric or metallic wires placed on the rear side of the at least one screening fabric and supporting the at least one screening fabric.

5. A screening installation according to claim 4, further comprising at least one heat detection wire arranged above the first set of polymeric or metallic wires.

6. A screening installation according to claim 2, wherein each of the linear heat detection wires comprise two twisted electrically conductive cables insulated by a polymer, which has a melting point greater than 80° C.

7. A screening installation according to claim 2, wherein the distance between vicinal linear heat detection wires is in the range from 1 m to 50 m.

8. A screening installation for detecting a fire in a greenhouse, comprising:
at least one screening fabric that has an upper side and a rear side;
a first set of polymeric or metallic wires arranged proximate to the upper side of the at least one screening fabric so that a displacement of the fabric is restricted; and
a second set of polymeric or metallic wires placed on the rear side of the at least one screening fabric and supporting the at least one screening fabric, wherein
at least one of the polymeric or metallic wires in the second set of polymeric or metallic wires is replaced by a linear heat detection wire and/or
the second set of polymeric or metallic wires is supplemented with at least one linear heat detection wire.

9. A screening installation according to claim 8, wherein at least the second set of polymeric wires comprises at least two linear heat detection wires and wherein the distance between adjacent linear heat detection wires is in the range from 1 m to 200 m.

10. A screening installation according to claim 9, wherein the distance between adjacent linear heat detection wires is in the range from 1 m to 50 m.

11. A screening installation according to claim 8, wherein each of the linear heat detection wires comprise two twisted electrically conductive cables insulated by a polymer, which has a melting point greater than 80° C.

12. A screening installation according to claim 8, further comprising at least one heat detection wire arranged above the first set of polymeric or metallic wires.

13. A screening installation according to claim 9, wherein each of the linear heat detection wires comprise two twisted electrically conductive cables insulated by a polymer, which has a melting point greater than 80° C.

14. A screening installation for detecting a fire in a greenhouse, comprising:
at least one screening fabric that has an upper side and a rear side;
a first set of polymeric or metallic wires arranged proximate to the upper side of the at least one screening fabric so that a displacement of the fabric is restricted; and
a second set of polymeric or metallic wires placed on the rear side of the at least one screening fabric and supporting the at least one screening fabric, wherein
at least one of the polymeric or metallic wires in the first and/or second set of polymeric or metallic wires is replaced by a linear heat detection wire and/or
the first and/or second set of polymeric or metallic wires is supplemented with at least one linear heat detection wire.

15. A screening installation according to claim 14, wherein at least the second set of polymeric wires comprises at least two linear heat detection wires and wherein the distance between adjacent linear heat detection wires is in the range from I m to 200 m.

16. A screening installation according to claim 15, wherein the distance between adjacent linear heat detection wires is in the range from 1 m to 50 m.

17. A screening installation according to claim 14, wherein each of the linear heat detection wires comprise two twisted electrically conductive cables insulated by a polymer, which has a melting point greater than 80° C.

18. A screening installation according to claim 14, further comprising at least one heat detection wire arranged above the first set of polymeric or metallic wires.

19. A screening installation according to claim 15, wherein each of the linear heat detection wires comprise two twisted electrically conductive cables insulated by a polymer, which has a melting point greater than 80° C.

20. A screening installation according to claim 19, wherein each of the linear heat detection wires comprise two twisted electrically conductive cables insulated by a polymer, which has a melting point greater than 100° C.
